(19) United States
(12) Patent Application Publication
(10) Pub. No.: US 2009/0085986 A1
(43) Pub. Date: Apr. 2, 2009

(54) LIQUID JET HEAD, METHOD FOR DRIVING THE SAME AND PRINTER USING THE SAME

(75) Inventor: Akihito MATSUMOTO, Chino (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/206,830

(22) Filed: Sep. 9, 2008

(30) Foreign Application Priority Data
Oct. 2, 2007 (JP) 2007-258341

(51) Int. Cl. B41J 2/045

(52) U.S. Cl. 347/70

(57) ABSTRACT

A liquid jet head includes: a pressure chamber substrate having a pressure chamber that is filled with liquid, and at least one nozzle aperture that is provided below the pressure chamber and connects to the pressure chamber; a vibration layer that is provided above the pressure chamber substrate and composes an upper surface of the pressure chamber; at least one cantilever beam section that is provided above the vibration layer and has a tip portion protruding above the pressure chamber in a plan view; and a piezoelectric element that is provided above the beam section and drives the beam section, wherein a plurality of the beam sections are provided, each of the beam sections operable to give vibration to the vibration layer, the vibration layer deforms by a plurality of the vibrations superposed propagating in the vibration layer, and the liquid is ejected through the nozzle aperture by the deformation of the vibration layer.

The entire disclosure of Japanese Patent Application No. 2007-258341, filed Oct. 2, 2007 is expressly incorporated by reference herein.

### BACKGROUND

1. Technical Field

The present invention relates to liquid jet heads, methods for driving the same, and printers using the same.

2. Related Art

Liquid jet heads have been placed in use not only for printing heads for ink jet printers but also for commercial and industrial purposes. For example, liquid jet heads are more frequently used for coating various kinds of liquid in semiconductor manufacturing processes, and for coating various kinds of liquid on media other than paper for industrial purposes. In such applications, precision printing is important, and therefore further reduction in the size of liquid jet heads is demanded. In recent years, liquid jet heads have been more frequently manufactured as MEMS (Micro Electro Mechanical Systems) using semiconductor manufacturing technology for further size reduction. However, while further size reduction of liquid jet heads is achieved, new problems are arising.

For example, when the size of a liquid jet head is reduced, its liquid discharging force (ejection force) may lower. To address such a problem, Japanese laid-open patent application JP-A-11-34316 describes a liquid jet head that ejects liquid that uses a cantilever member that causes a larger displacement than that of a fixed-fixed beam member. Also, a driving section may be disposed in a manner to be in direct contact with liquid in order to increase the discharging force. However, in this case, there is a concern that deterioration may occur in the driving section due to the liquid, and therefore the kinds of liquid to be used may be limited. In order to address this problem, Japanese laid-open patent application JP-A-2002-240274 describes a printer head in which a vibration plate composing an ink chamber is stricken by a movable piece driven by electrostatic force to discharge ink droplets.

However, a liquid jet head that uses a cantilever configuration having a large displacement in which its driving section is not in direct contact with liquid is difficult to be realized if the conventional liquid jet head driving mechanism is used. Moreover, the aforementioned method using electrostatic force is not desirable in size-reduction of heads, as the method requires high voltage.

### SUMMARY

In accordance with an advantage of some aspects of the invention, there are provided a novel liquid jet head in small size with high discharge force and high reliability, a method for driving the liquid jet head, and a printer equipped with the liquid jet head.

A liquid jet head in accordance with an embodiment of the invention includes: a pressure chamber substrate having a pressure chamber that is filled with liquid, and at least one nozzle aperture that is provided below the pressure chamber and connects to the pressure chamber; a vibration layer that is provided above the pressure chamber substrate and composes an upper surface of the pressure chamber; at least one cantilever beam section that is provided above the vibration layer and has a tip portion protruding above the pressure chamber in a plan view; and a piezoelectric element that is provided above the beam section and drives the beam section, wherein a plurality of the beam sections are provided, each of the beam sections operable to give vibration to the vibration layer, the vibration layer deforms by a plurality of the vibrations superposed and propagating in the vibration layer, and the liquid is ejected through the nozzle aperture by the deformation of the vibration layer.

The liquid jet head composed in this manner is small in size, has a high discharging force, and is highly reliable.

In the present invention, the statement “a specific member provided above another specific member A” includes the case where the member B is provided directly on the member A, and the case where the member B is provided over the member A through another member provided on the member A.

In the liquid jet head in accordance with an aspect of the embodiment, the deformation of the vibration layer may have a maximum magnitude above the nozzle aperture.

In the liquid jet head in accordance with an aspect of the embodiment, the beam section may have a tip portion protruding toward the nozzle aperture in a plan view.

In the liquid jet head in accordance with an aspect of the embodiment, at least two of the beam sections may be provided opposite to each other through the nozzle aperture.

In the liquid jet head in accordance with an aspect of the embodiment, a plurality of the nozzle apertures may be arranged in a first direction that connects centers of the beam sections provided opposite to one another.

In the liquid jet head in accordance with an aspect of the embodiment, the beam sections may be provided such that the tip sections of the beam sections point toward the nozzle apertures located at both ends of the first direction, and arranged along the first direction.

In the liquid jet head in accordance with an aspect of the embodiment, the beam sections may be provided opposite to one another through the nozzle apertures, and arranged along a second direction traversing the first direction.

In the liquid jet head in accordance with an aspect of the embodiment, the pressure chamber substrate may have a plurality of pressure chambers.

In the liquid jet head in accordance with an aspect of the embodiment, the plurality of pressure chambers may be disposed in a line.

In the liquid jet head in accordance with an aspect of the embodiment, the plurality of pressure chambers may be disposed in a matrix.

In the liquid jet head in accordance with an aspect of the embodiment, the nozzle apertures of the plurality of pressure chambers may be disposed in a matrix.

In the liquid jet head in accordance with an aspect of the embodiment, at least one of the nozzle apertures disposed in a matrix may be an auxiliary nozzle aperture.

A method for driving a liquid jet head in accordance with an embodiment of the invention pertains to a method for driving one of the liquid jet heads described above, wherein a plurality of vibrations given by a plurality of beam sections and propagating in the vibration layer are mutually different from one another in at least one of phase, cycle and amplitude.

As a result, the vibration layer can be deformed according to vibrations that propagate in the vibration layer, whereby liquid can be ejected from the nozzle aperture.

In the method for driving a liquid jet head in accordance with an aspect of the embodiment, the plurality of vibrations may be mutually different in cycle.

In the method for driving a liquid jet head in accordance with an aspect of the embodiment, each of the cycles of the plurality of vibrations may be a multiple of a specified cycle.

A printer in accordance with an embodiment of the invention is quipped with any one of the liquid jet heads set forth above.

### BRIEF DESCRIPTION OF THE DRAWINGS

FIG. 1 is a schematic plan view of a liquid jet head 100 in accordance with an embodiment of the invention.

FIG. 2 is a schematic cross-sectional view of the liquid jet head 100 in accordance with the present embodiment.

FIG. 3 is a schematic cross-sectional view showing an operation of the liquid jet head 100 in accordance with the present embodiment.

FIG. 4 is a schematic cross-sectional view showing an operation of the liquid jet head 100 in accordance with the present embodiment.

FIG. 5 is a graph schematically showing a shape of an upper surface of a pressure chamber 12 in accordance with an embodiment of the invention.

FIG. 6 is a graph schematically showing a shape of the upper surface of the pressure chamber 12 in accordance with the present embodiment.

FIG. 7 is a schematic plan view of a liquid jet head 200 in accordance with an embodiment of the invention.

FIG. 8 is a schematic plan view of a liquid jet head 300 in accordance with an embodiment of the invention.

FIG. 9 is a graph schematically showing a shape of an upper surface of a pressure chamber 12 in accordance with a present embodiment.

FIG. 10 is a schematic plan view of a liquid jet head 400 in accordance with an embodiment of the invention.

FIG. 11 is a schematic plan view of a liquid jet head 450 in accordance with an embodiment of the invention.

FIG. 12 is a schematic plan view of a liquid jet head 480 in accordance with an embodiment of the invention.

FIG. 13 is a schematic plan view of a liquid jet head 500 in accordance with an embodiment of the invention.

FIG. 14 is a schematic plan view of a liquid jet head 550 in accordance with an embodiment of the invention.

FIG. 15 is a schematic plan view of a liquid jet head 580 in accordance with an embodiment of the invention.

FIG. 16 is a schematic perspective view of a printer 600 in accordance with an embodiment of the invention.

### DESCRIPTION OF EXEMPLARY EMBODIMENTS

Preferred embodiments of the invention are described below with reference to the accompanying drawings. However, it should be noted that the embodiments described below are examples of the invention, and not all components described below may be essential to the invention.

### 1. FIRST EMBODIMENT

### 1.1. LIQUID JET HEAD

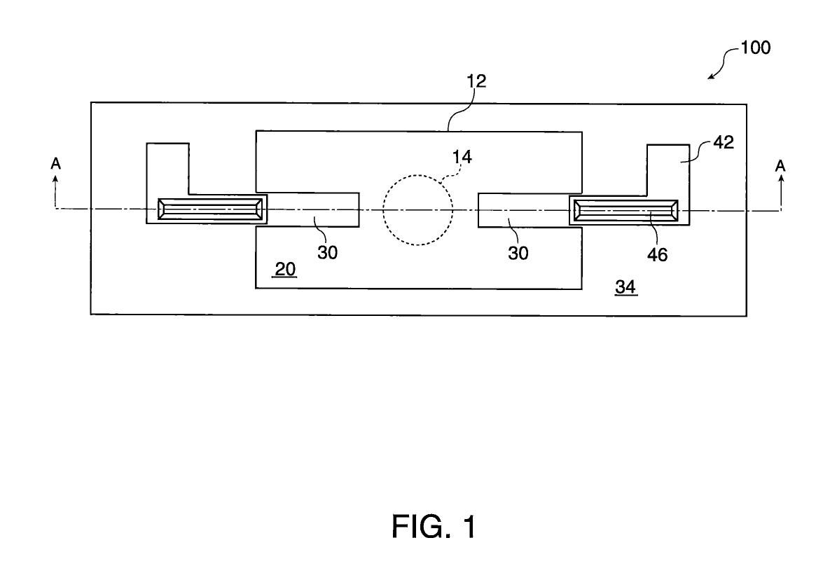

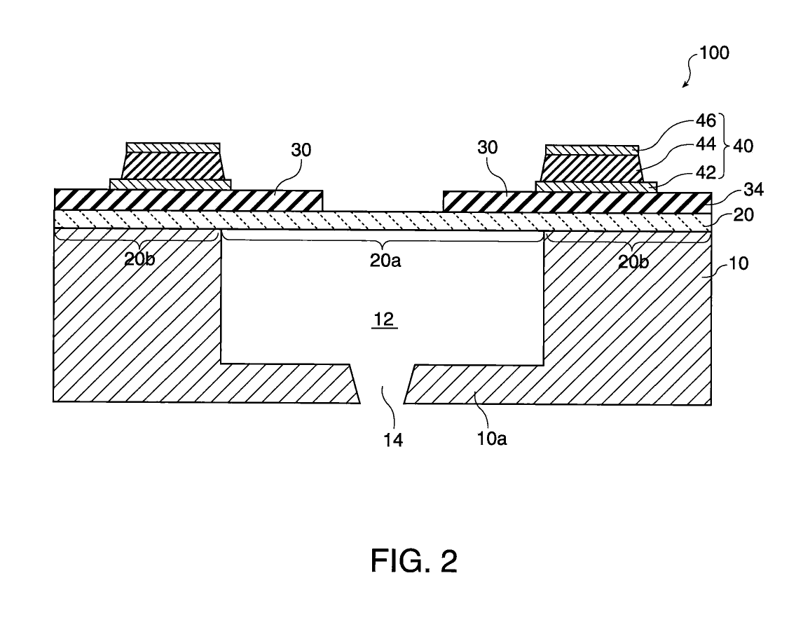

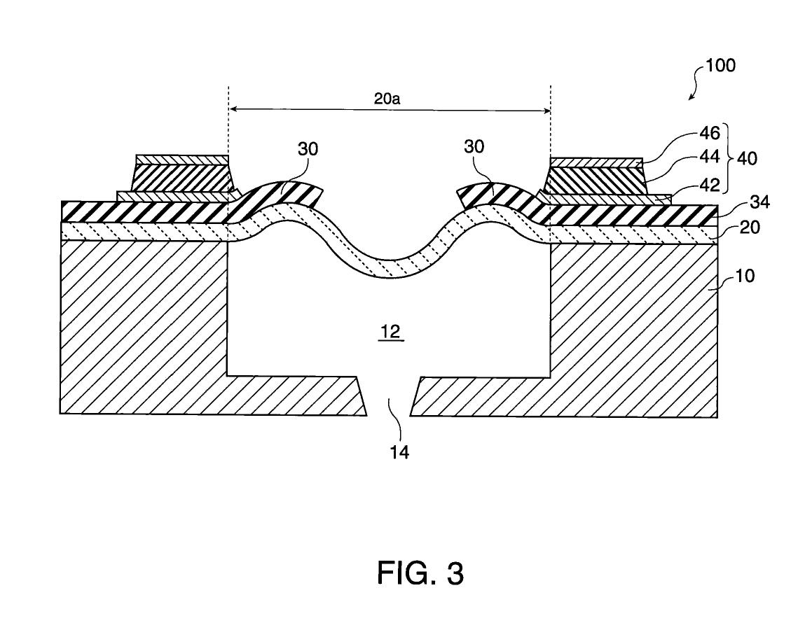

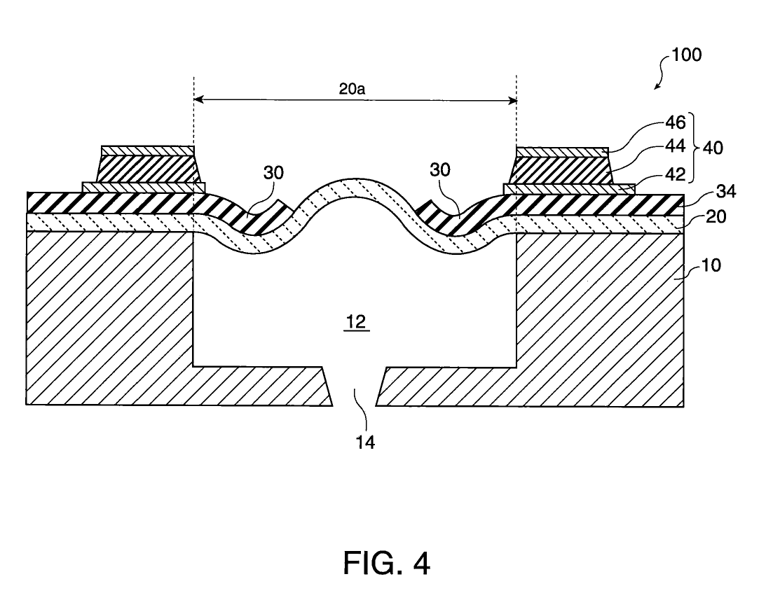

FIG. 1 is a schematic plan view of a liquid jet head 100 in accordance with an embodiment of the invention. FIG. 2 is a schematic cross-sectional view of the liquid jet head 100, which shows a cross section taken along a line A-A of FIG. 1. FIGS. 3 and 4 are cross-sectional views schematically showing states of vibrations of the liquid jet head 100. FIGS. 3 and 4 show momentary configurations of a vibration layer 20 that can assume when deformed.

As shown in FIG. 1 and FIG. 2, the liquid jet head 100 in accordance with the present embodiment includes a pressure chamber substrate 10, a vibration layer 20, beam sections 30 (first beam sections), and piezoelectric elements 40. The liquid jet head 100 of the present embodiment is provided with a nozzle aperture 14 and two beam sections 30 for one pressure chamber 12.

The pressure chamber substrate 10 has a pressure chamber 12 and a nozzle aperture 14 provided in a bottom section 10a that composes a lower surface of the pressure chamber 12. Liquid to be discharged is filled in the pressure chamber 12. The pressure chamber 12 connects to a flow path (not shown), and liquid can be supplied in the pressure chamber 12 through the flow path. The pressure chamber 12 is connected to an external liquid reservoir (not shown) through the flow path. The cross-section and plan configuration of the pressure chamber 12 may be rectangular as illustrated, or may be in other shapes. The volume of the pressure chamber 12 changes as the vibration layer 20 at the upper surface of the pressure chamber 12 deforms. When the volume of the pressure chamber 12 changes, the pressure inside the pressure chamber 12 changes, whereby liquid can be discharged through the nozzle aperture 14, or liquid may be taken in through the flow path by the pressure change.

The nozzle aperture 14 is a nozzle for discharging liquid from within the pressure chamber 12 to outside. The shape of the nozzle aperture 14 may have a circular plane configuration in the illustrated example, and has a taper, but may have other configurations. The shape of the nozzle aperture 14 may be more complex, and can be freely designed according to the property (viscosity and the like) of the liquid to be discharged. Any material may be selected for the pressure chamber substrate 10 without any particular limitation. As the material for the pressure chamber substrate 10, silicon, stainless steel, SUS, nickel, titanium, titanium alloy or the like may be used. When silicon is used as the material for the pressure chamber substrate 10, the pressure chamber substrate 10 can be formed by processing the silicon substrate. As a result, the pressure chamber substrate can be formed by using semiconductor manufacturing technology, whereby further size-reduction is facilitated.

In accordance with the present embodiment, the nozzle aperture 14 is formed in one piece with the pressure chamber substrate 10 in its bottom section 10a. However, the pressure chamber substrate 10 may be formed from a member that composes only side walls of the pressure chamber 12, and an independent nozzle plate (not shown) having a nozzle aperture formed therein.

The vibration layer 20 is provided above the pressure chamber substrate 10, and has a portion composing an upper surface of the pressure chamber 12. The vibration layer 20 is provided in a manner to seal the pressure chamber 12. The shape of the vibration layer 20 may have a flat plate shape. The vibration layer 20 has a vibration region 20a located above the pressure chamber 12, and a fixed region 20b that is in contact with the pressure chamber substrate 10. The vibration region 20a is capable of changing the volume of the pressure chamber 12 by deformation.

Deformation or vibration of the vibration region 20a of the vibration layer 20 can propagate in a plane of the vibration layer 20 within the vibration region 20a. For example, the vibration region 20 of the vibration layer 20 can operate like a drum skin extended over the pressure chamber 12.

The vibration region 20a of the vibration layer 20, which composes an upper surface of the pressure chamber 12 at the vibration layer 20, is capable of deforming like a vibrating string in a specified cross section, as shown in FIG. 3 and FIG. 4. By this, the volume of the pressure chamber 12 can be changed at specified moments. As shown in FIG. 3 and FIG. 4, the vibration region 20a of the vibration layer 20 can be deformed, as a momentary configuration at the time of deformation, such that the maximum displacement thereof is located above the nozzle aperture 14. The deformation of the vibration region 20a of the vibration layer 20 propagates in the vibration layer 30 like waves, and the vibration region 20a of the vibration layer 20 deforms according to a shape of the synthesized multiple waves. Details of deformations of the vibration region 20a of the vibration layer 20 are described in detail below. Any material having appropriate bendability and flexibility may be used for the vibration layer 20, and for example, inorganic oxides such as silicon oxide, zirconium oxide and the like, inorganic nitrides such as silicon nitride and the like, metal such as platinum and the like, or polymer material such as polyimide and the like may be used.

The beam sections 30 are provide above the vibration layer 20. The beam sections 30 each have a cantilever shape. The beam sections 30 are provided in a manner that their tip portions protrude over the pressure chamber 12 in a plan view, as shown in FIG. 1 and FIG. 2. The beam sections 30 may be continuously formed from a base section 34 in one piece, as shown in FIG. 1. The base section 34 is formed above the vibration layer 20. The base section 34 is formed outside the pressure chamber 12 as viewed in a plan view. Portions of the base section 34 may be removed by etching in a manner that the beam sections 30 are left remained. The base section 34 and the beam sections 30 may be composed of the same material or different materials. At least a portion of the beam sections 30 is provided above the pressure chamber 12, in other words, above the vibration region 20a of the vibration layer 20. In the illustrated example, the beam sections 30 and the nozzle aperture 14 are positioned in a manner that the beam sections 30 are provided outside of a region vertically above the nozzle aperture 14. However, they may be positioned such that the beam sections 30 overlap the region vertically above the nozzle aperture 14. In the illustrated example, the beam sections 30 may be provided in a manner that the tip portions of the cantilevers extend toward the nozzle aperture 14. As a result, the longitudinal direction of the beam sections 30 extending toward their tips and the direction in which vibrations should be propagated can be matched to each other, and therefore vibrations of the beam sections 30 can be more effectively transmitted to the vibration layer 20. In the illustrated example, two beam sections 30 are provided for one nozzle aperture 14. It is noted that, when two beam sections 14 are provided opposite to each other through one nozzle aperture 14, as shown in FIG. 1 and FIG. 2, vibrations propagating in the vibration layer 20 are in mutually opposite directions, and therefore the position of the maximum displacement of the vibration layer 20 can be more readily set within the region vertically above the nozzle aperture 14.

The beam sections 30 vibrate the vibration layer 20 provided therebelow. The beam section 30 may preferably have a so-called unimorph configuration, such that a tip of a cantilever can vibrate up and down. The beam section 30 is in a cantilever shape, and thus has a greater vibration amplitude at its tip portion, compared to a fixed-fixed beam shape. Accordingly, the displacement of the vibration layer 20 can be made greater, and the discharging force of the liquid jet head 100 can be made greater. Also, the distance between the nozzle aperture 14 and the tip of the beam section 30 may be arbitrarily decided as long as vibrations can propagate in the vibration layer 20. The distance in which vibrations propagate change depending on the material of the vibration layer 20, the viscosity of liquid and the like. Any material having a predetermined degree of elasticity may be used for the beam sections 30, and for example, semiconductor material such as silicon, inorganic oxides such as silicon oxide, zirconium oxide and the like, inorganic nitrides such as silicon nitride and the like, or metal such as platinum and the like can be used.

The piezoelectric elements 40 are provided above the beam sections 30. The piezoelectric element 40 is formed from a lower electrode 42, a piezoelectric layer 44 and an upper electrode 46, in this order from its lower side. The lower electrode 42 has electrical conductivity and is formed from, for example, platinum or the like. The piezoelectric layer 44 has piezoelectricity, and may be formed from, for example, lead titanate zirconate, lead titanate zirconate niobate, or the like. The upper electrode 46 has electrical conductivity and is formed from, for example, platinum or the like. The piezoelectric layer 44 is interposed between the lower electrode 42 and the upper electrode 46, such that, upon application of an electric field by the electrodes, the piezoelectric layer 44 can deform according to the electric filed. The deformation of the piezoelectric layer 44 is transmitted to the beam section 30 through the lower electrode 42, whereby the beam section 30 can be vibrated or deformed. The position where the lower electrode 42 is formed would not necessarily be directly above the beam section 30 as long as vibrations can be generated in the beam section 30. For example, the lower electrode 42 may be formed at a position where the beam section 30 connects to the base section 34. At least one piezoelectric element 40 may be provided on each of the beam sections 30. The lower electrode 42 and the upper electrode 46 of the piezoelectric element 40 are connected to a circuit (not shown). When a plurality of piezoelectric elements 40 are provided, the lower electrodes 42 may be formed by a common electrode. With such a connection structure, the plurality of beam sections 30 can be operated differently from one another.

### 1.2. DRIVING METHOD FOR LIQUID JET HEAD

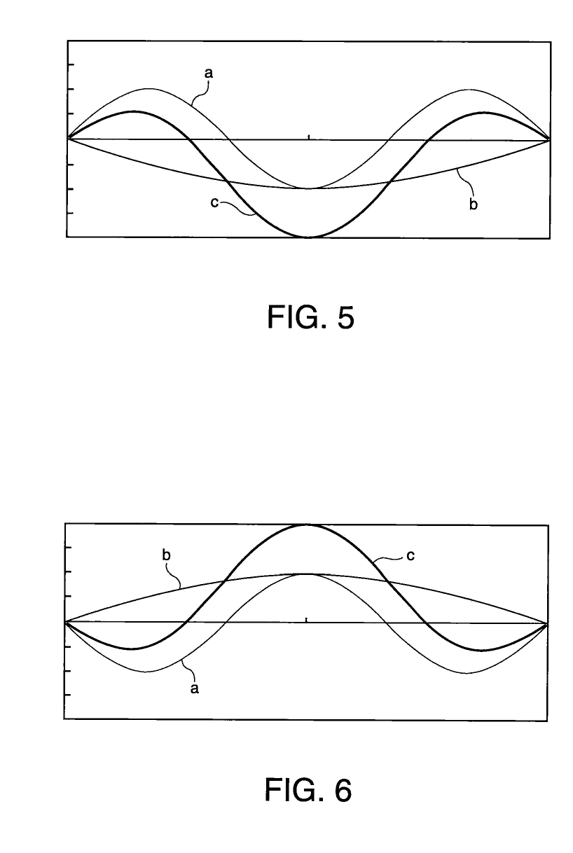

FIG. 3 and FIG. 4 are cross-sectional views schematically showing the shapes of the liquid jet head 100 in its operation. FIG. 5 and FIG. 6 are graphs schematically showing the shapes of the upper surface of the pressure chamber 12 in its cross section which can momentarily assume. The upper surface of the pressure chamber 12 corresponds to the lower surface of the vibration region 20a of the vibration layer 20 described above. FIGS. 5 and 6 are graphs in which distances are plotted along the horizontal axis, and amounts of displacement of the upper surface of the pressure chamber 12 are plotted along the vertical axis. Both ends of the horizontal axis of the graph correspond to the ends of the vibration region 20a of the vibration layer 20.

Vibrations from the beam sections 30 are given to one ends of the vibration region 20a of the vibration layer 20, and the vibrations propagate toward the other ends. As the vibrations propagate within the vibration layer 20, the lower surface of the vibration layer 20 has a wave shape as illustrated at a specified moment. An example shown in FIG. 5 indicates the case where vibrations are given from the right end in a manner that a sine wave a advances toward the left end, and vibrations are given from the left end in a manner that a sine wave b with a cycle three times the cycle of the sine wave a propagates toward the right end. In the figure, a synthesized wave c is formed by superposition of the sine wave a and the sine wave b, and presents a momentary shape of the lower surface of the vibration region 20a of the vibration layer 20. The synthesized wave c shown in FIG. 5 has the largest (maximum) displacement amount near the center. With the arrangement of the pressure chamber 14 and the nozzle aperture 12, as shown in FIG. 1 and FIG. 2, when the vibration region 20a of the vibration layer 20 has the shape shown in FIG. 5, the pressure of liquid near the nozzle aperture 14 is momentarily elevated. In this case, the liquid jet head 100 assumes a configuration shown in FIG. 3, whereby liquid can be discharged through the nozzle aperture 14. Conversely, as shown in FIG. 6, when the phases of the waves generated from the right and left sides are placed in a state reversed with respect to those shown in FIG. 5, in other words, when the waves are in a reversed state along the vertical axis with respect to those shown in FIG. 5, the volume of the pressure chamber 12 increases. The configuration of the liquid jet head 100 in this case is shown in FIG. 4. When the volume of the pressure chamber 12 increases, the pressure inside the pressure chamber 12 lowers, such that liquid can be taken in from the flow path. It is noted that a surface tension of the liquid is generated near the nozzle aperture 14 at an interface with gas atmosphere. Therefore, it is more advantageous in terms of energy to flow the liquid into the pressure chamber 12 from the flow path than forming a bubble inside the pressure chamber 12. Accordingly, when the pressure inside the pressure chamber 12 is reduced, liquid is sacked in from the flow path more preferentially than discharging liquid from the nozzle aperture 14.

According to the liquid jet head 100 of the present embodiment, two vibrations generated by the two beam sections 30 are superposed with each other, and a deformation corresponding to the superposition of the vibrations is generated in the vibration layer 20 whereby liquid can be discharged. Also, the cycle, phase and amplitude of sine waves can be changed with the lapse of time. Although the above operation is described by using sine waves, vibrations given to the vibration layer 20 by the beam sections 30 may be vibrations whose displacements propagating in the vibration layer 20 are in rectangular waves, pulse waves or the like.

### 1.3. METHOD FOR MANUFACTURING LIQUID JET HEAD

As an example of a method for manufacturing a liquid jet head, a method for manufacturing the liquid jet head 100 is described below.

A pressure chamber substrate 10 may be formed from, for example, a silicon substrate having a pressure chamber 12 and a nozzle aperture 14 which are provided therein by etching, using photolithography or the like. A vibration layer 20 may be formed from, for example, a commercially-available polyimide film. Beam sections 30 may be formed from, for example, a zirconium oxide substrate, which is etched by a photolithography method in a manner to form a base section 32 and the beam sections 30. Piezoelectric elements 40 may be formed, for example, before forming the beam sections 30, through forming laminated layers for a lower electrode 42, a piezoelectric layer 44 and an upper electrode 46, and patterning the laminated layers by a photolithography method or the like. In this manner, the pressure chamber substrate 10, the vibration layer 20, the beam sections 30 and the piezoelectric elements 40 are prepared, and then these members are disposed at predetermined positions, using a known alignment device and assembled together by using adhesive or the like depending on the necessity, whereby a liquid jet head 100 is manufactured. Also, when the lower section of the pressure chamber substrate 10 is formed from a nozzle plate, they can be similarly assembled by using adhesive or the like.

### 1.4. EFFECTS

The liquid jet head 100 in accordance with the present embodiment is small in size and has high discharge force and high reliability. The liquid jet head 100 uses propagation of vibrations in the vibration layer 20 to discharge liquid, which is an unprecedented novel liquid jet head. Semiconductor manufacturing technology can be used to manufacture the liquid jet head 100 in accordance with the present embodiment. As a result, the liquid jet head 100 can be manufactured in a smaller size, and nozzles 14 can be arranged in a higher density. The liquid jet head 100 in accordance with the present embodiment is driven by using vibrations of the cantilever type beam sections 30. Accordingly, the liquid jet head 100 can generate vibrations in greater amplitude than those of a fixed-fixed beam type head, and can generate greater liquid discharge force. Accordingly, the liquid jet head 100 can readily discharge high-viscosity liquid, such as, for example, ink containing polymerizing monomer and photopolymerization initiator and the like. Also, the liquid jet head 100 can be applied not only to printing on paper but also to printing on other media, in other words, can accommodate so-called industrial printing. Also, in the liquid jet head 100 in accordance with the present embodiment, the beam sections 30 and the piezoelectric elements 40 do not contact liquid. As a result, the beam sections 30 and the piezoelectric elements 40 would not readily be deteriorated, and therefore the liquid jet head 100 is highly reliable and is applicable to ejection of a wide range of liquids. Furthermore, the liquid jet head composed in the manner described above can be manufactured by using semiconductor manufacturing technology, and is thus small in size.

### 2. SECOND EMBODIMENT

### 2.1. LIQUID JET

Liquid jet heads in accordance with a second embodiment are described below. The liquid jet head of the second embodiment is provided with a plurality of nozzle apertures 14 for a single pressure chamber 12.

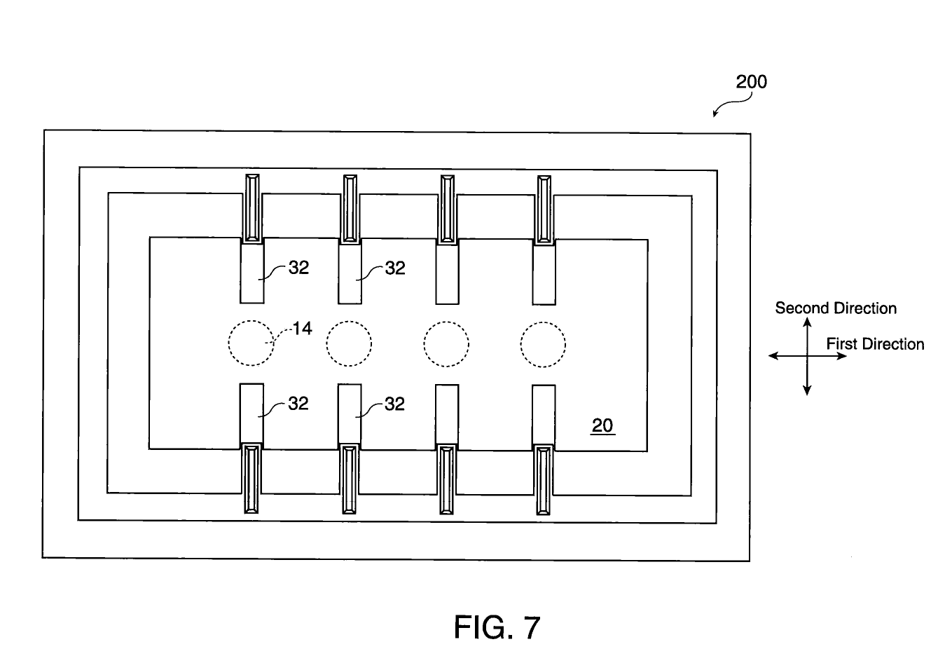

FIG. 7 is a schematic plan view of a liquid jet head 200 in accordance with the second embodiment.

In the liquid jet head 200, a plurality of nozzle apertures 14 arranged in a line are provided for a single pressure chamber 12. In the example shown in FIG. 7, four nozzle apertures 14 are illustrated, for simplification. As shown in FIG. 7, the direction in which the nozzle apertures 14 are arranged is defined as a first direction. Accordingly, in the example shown in FIG. 7, it can be said that the first direction is a direction of a line connecting center points of pairs of oppositely provided beam sections 32. Also, a direction traversing the first direction is defined as a second direction. In the present example, the first direction and the second direction are orthogonal to each other. In the liquid jet head 200, two each of the beam sections 32 (second beam sections) are provided along the second direction for each of the nozzle apertures 14. Each of the beam sections 32 is generally the same as the beam section 30 described in the first embodiment. Each of the members and operations of the liquid jet head 200 is generally the same as the first embodiment. Detailed description of the contents that may be repetitive of the first embodiment shall be omitted.

According to the liquid jet head 200, the beam sections 32 can be driven in a manner that liquid is discharged from each of the nozzle apertures 14, and common liquid can be filled in the pressure chamber 12. By selectively driving the beam sections 32, it is possible to control such that liquid is ejected from each of the nozzle apertures 14 independently from one another. Therefore, the liquid jet head 200 can be used as a so-called line head in which the plural nozzle apertures 14 are arranged in a line. As a result, the efficiency in printing can be improved. Also, the liquid jet head 200 can be made very small in size compared to conventional line heads, and excels in liquid discharging force. The actions and effects described above are similarly applied to modified examples to be described below.

### 2.2. MODIFIED EXAMPLE 1

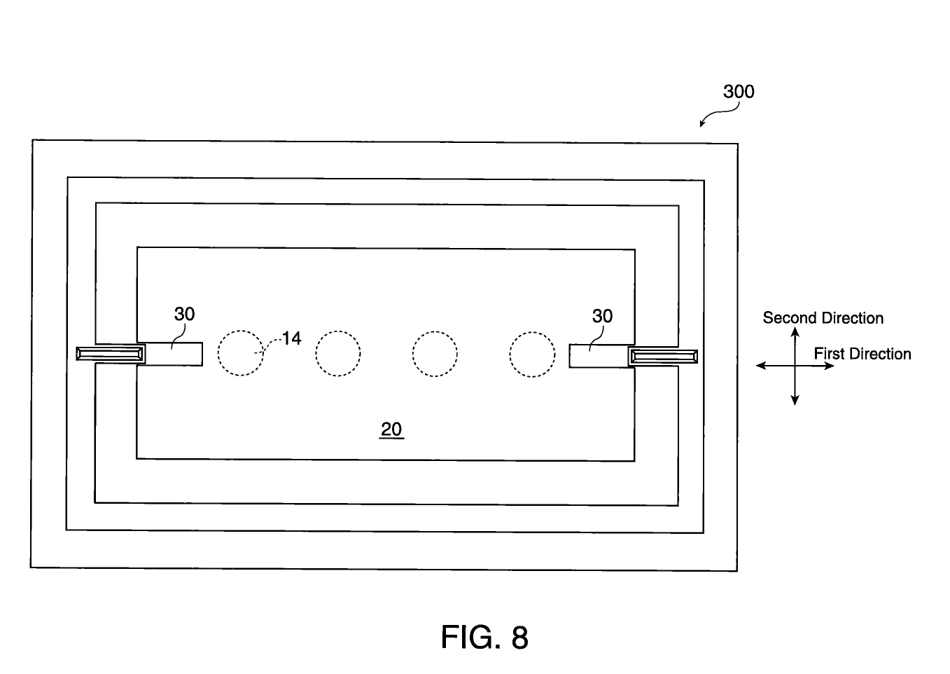

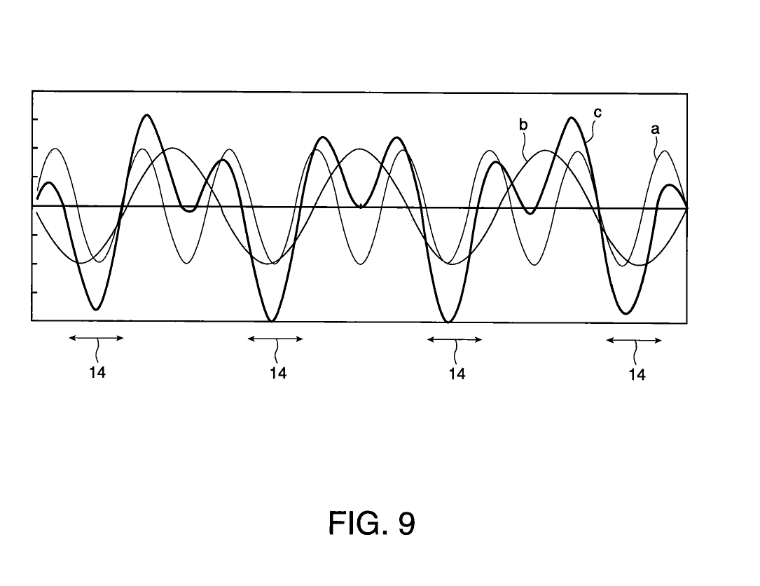

FIG. 8 is a schematic plan view of a liquid jet head 300 in accordance with Modified Example 1. FIG. 9 is a graph schematically showing a shape of an upper surface of a pressure chamber 12 of the liquid jet head 300 which can assume momentarily. FIG. 9 is a graph in which distances are plotted along the horizontal axis and amounts of displacement of the upper surface of the pressure chamber 12 are plotted along the vertical axis. The ends of the horizontal axis of the graph correspond to the ends of a lower surface of a vibration region 20a of a vibration layer 20 that composes an upper surface of the pressure chamber 12.

In the liquid jet head 300 in accordance with the present modified example, nozzle apertures 14 are arranged in a line in the first direction and beam sections 30 are provided only at both ends of the line along the first direction. The composition of the liquid jet head 300 in accordance with the present modified example and its manufacturing method are generally the same as those of the liquid jet head 100 in accordance with the first embodiment described above, and therefore their detailed description is omitted. Operations of the liquid jet head 300 in accordance with the present modified example are described below.

As shown in FIG. 9, by adjusting the cycles, phases and amplitudes of sine waves generated in the vibration region 20a of the vibration layer 20 caused by vibrations of the beam sections 30, pressures at specified positions within the pressure chamber 14 can be instantaneously changed. Vibrations given to the vibration layer 20 by each of the beam sections 30 can be selected by setting at least one of the cycles, the phases and the amplitudes to be different from each other. Therefore, even in the case of the present modified example where a plurality of (four) nozzle apertures 14 are provided for a single pressure chamber 12, the upper surface of the pressure chamber 12 can be displaced such that pressures near the respective nozzle apertures 14 can be instantaneously elevated at desired timings. More specifically, in the example shown in FIG. 9, a sine wave a is generated in a manner to advance from the right end toward the left end, and a sine wave b with a cycle ( 15/7) times the cycle of the sine wave a is generated in a manner to advance from the left end toward the right end. In this case, the cycle of the base sine wave is 1/7 times the cycle of the sine wave a, the sine wave a has a cycle seven times the cycle of the base sine wave, and the sine wave b has a cycle 15 times the cycle of the base sine wave. A synthesized wave c is created by superposition of the aforementioned waves. The synthesized wave c shown in FIG. 9 has the largest (maximum) displacement amounts at four locations in the pressure chamber 12. As shown in FIG. 9, when the nozzle apertures 14 are disposed at four locations at the positions shown in the figure, the amounts of displacement of the lower surface of the vibration layer 20 in regions vertically above the respective nozzle apertures 14 can be maximized.

According to the liquid jet head 300, the shape of the vibration layer 20 can be controlled such that its displacements can be maximized at any positions by adjusting vibrations to be added. Therefore, ejections from any arbitrary ones of the nozzle apertures 14 can be conducted at desired timings. Furthermore, the cycle, phase and amplitude of the sine waves can be changed with the lapse of time. Accordingly, the liquid jet head 300 can discharge liquid from any arbitrary ones of the nozzle apertures 14 in arbitrary amounts at arbitrary timings.

It is noted that, when multiple nozzle apertures 14 are provided in a line for a single pressure chamber 12, and the liquid jet head is driven by applying vibrations from two ends of the line, like in the present modified example, the number of the nozzle apertures 14 may preferably be 2 raised to the power of n (n is a natural number), whereby vibrations to be superposed can be simplified, and therefore the control efficiency is improved.

### 2.3. MODIFIED EXAMPLE 2

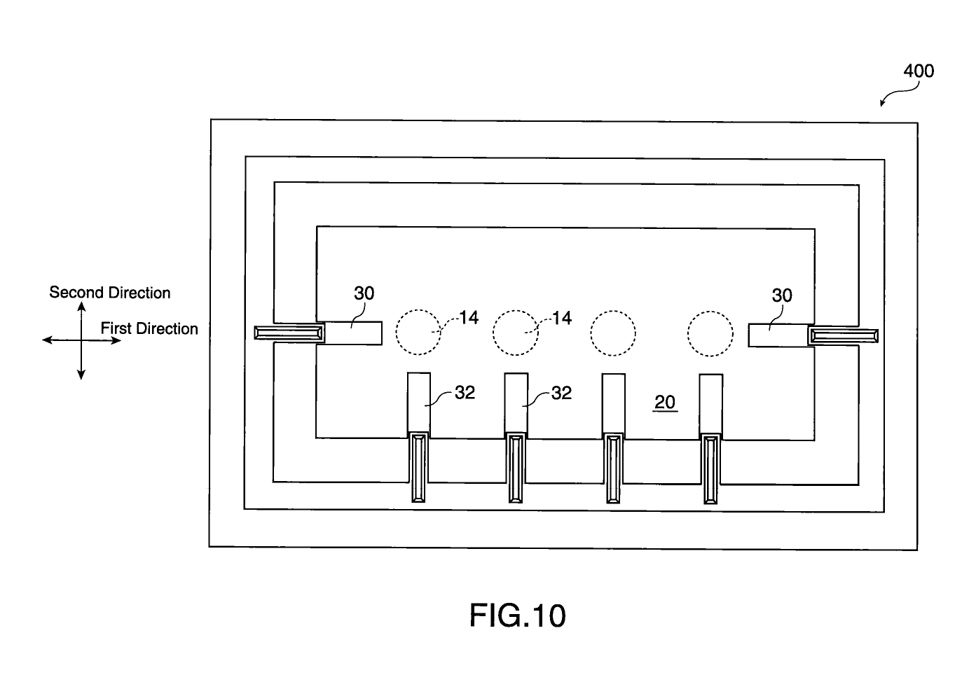

FIG. 10 is a schematic plan view of a liquid jet head 400 in accordance with Modified Example 2. As shown in FIG. 10, the liquid jet head 400 in accordance with the present modified example has plural beam sections 30 and 32. The present example is described as having six beam sections in total for simplification. The liquid jet head 400 has two beam sections 30 at both ends of a line connecting nozzle apertures 14 in one direction (first direction), and four beam sections 32 provided at positions corresponding to the respective nozzle apertures 14 arranged in another direction (second direction) orthogonal to the direction of the line connecting the nozzles 14. The beam sections 32 provided along the second direction of the liquid jet head 400 can vibrate the vibration layer 20, like the beam sections 30 provided along the first direction described above.

In the liquid jet head 400, as shown in FIG. 10, in addition to waves in the transverse direction (first direction), waves are propagated in the longitudinal direction (second direction) in the figure. The beam sections 32 that propagate vibrations in the longitudinal direction are provided corresponding to the respective nozzle apertures 14. Therefore, by superposing waves in the transverse direction and waves in the longitudinal direction above the nozzle apertures 14, liquid can be discharged from desired ones of the nozzle apertures 14. Also, for example, while a standing wave may be formed by the beam sections 30 in the first direction, waves in the longitudinal direction may be superposed above the respective nozzle apertures 14, whereby liquid can be controlled to be discharged from desired ones of the nozzle apertures 14. The liquid jet head 400 in accordance with the present modified example can be used as a line head. Accordingly, when the liquid jet head 400 is used for printing liquid (ink) on medium, such as, paper or the like, the printing speed can be improved. More over, in the liquid jet head 400, at least one beam section 32 in the second direction is provided for a specified one of the nozzle apertures 14 from which liquid is to be discharged, such that liquid can be more accurately and forcefully discharged. It is noted that, in the present modified example, the first direction and the second direction are orthogonal to each other, but similar effects can be obtained as long as they traverse each other, even if not orthogonal to each other.

If the width of the pressure chamber 12 in the first direction is small to the extent that vibrations from the beam section 30 on one end can propagate to the other end without being noticeably attenuated, the beam sections 30 may not necessarily be provided at both sides of the pressure chamber 12. According to such a liquid jet head 400, liquid can be more accurately discharged from each of the nozzle apertures 14 in a smaller space. It is noted that not all of the plural beam sections have to be provided in a manner to correspond to the nozzle apertures 14, respectively. It may be sufficient if vibrations generated by two or more beam sections 14 reach areas above the nozzle apertures 14.

### 2.4. MODIFIED EXAMPLE 3

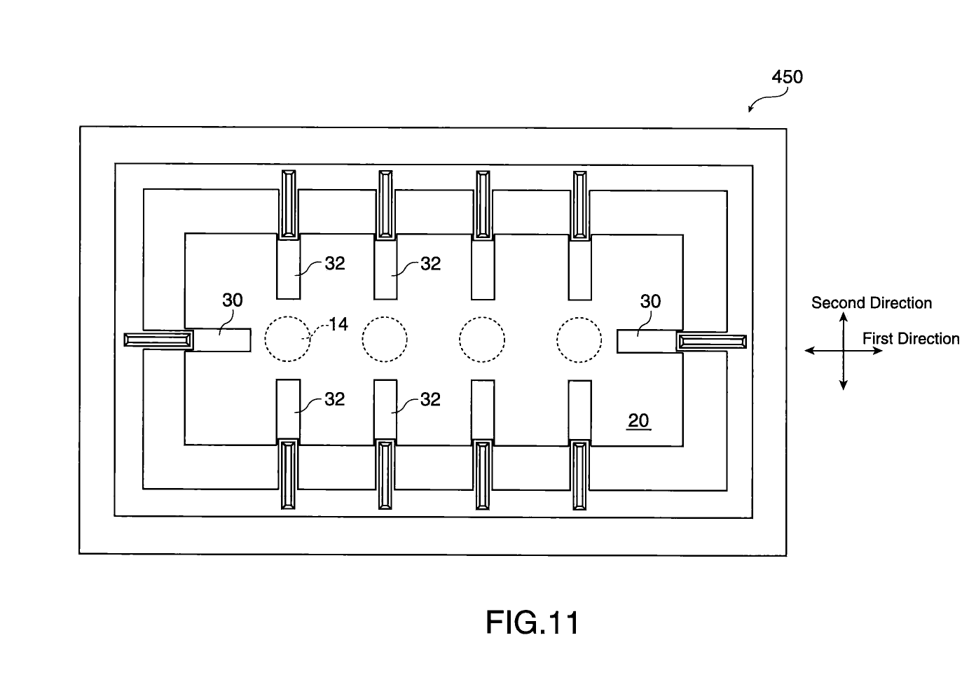

FIG. 11 is a schematic plan view of a liquid jet head 450 in accordance with Modified Example 3. The liquid jet head 450 in accordance with the present modified example has a structure that combines the liquid jet head 200 and the liquid jet head 300. More specifically, the liquid jet head 450 has two beam sections 30 at both ends of the pressure chamber 10 along the first direction, and pairs of (eight in total) beam sections 32 provided along the second direction at places corresponding to the nozzle apertures 14, respectively.

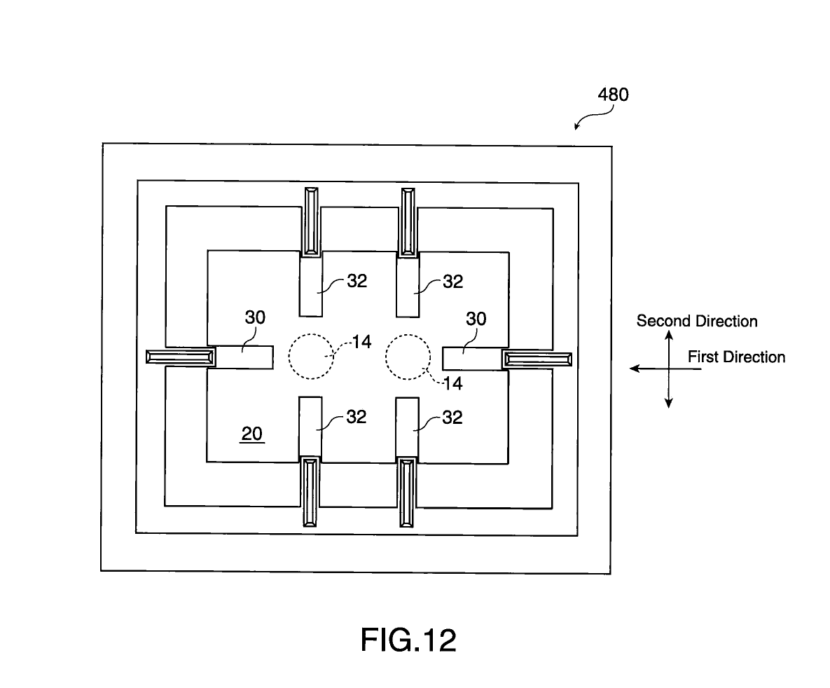

As shown in FIG. 11, in the liquid jet head 450 in accordance with the present modified example, the vibration energy transmitted over each of the nozzle apertures 14 is elevated by the increased beam sections 30, whereby the liquid discharging force is increased. Therefore, the liquid jet head 450 can discharge liquid having higher viscosity. Such an effect can be obtained more significantly by increasing the number of beam sections 30 that can propagate vibrations to each one of the nozzle apertures 14. For example, a liquid jet head 480 shown in FIG. 12 has a structure in which three beam sections 30 protrude toward each one of the nozzle apertures 14. This structure can accommodate liquid having higher viscosity.

### 3. THIRD EMBODIMENT

### 3.1. LIQUID JET HEAD

Liquid jet heads in accordance with a third embodiment are described below. The liquid jet head in accordance with the third embodiment is provided with a plurality of pressure chambers 12 in a pressure chamber substrate 10.

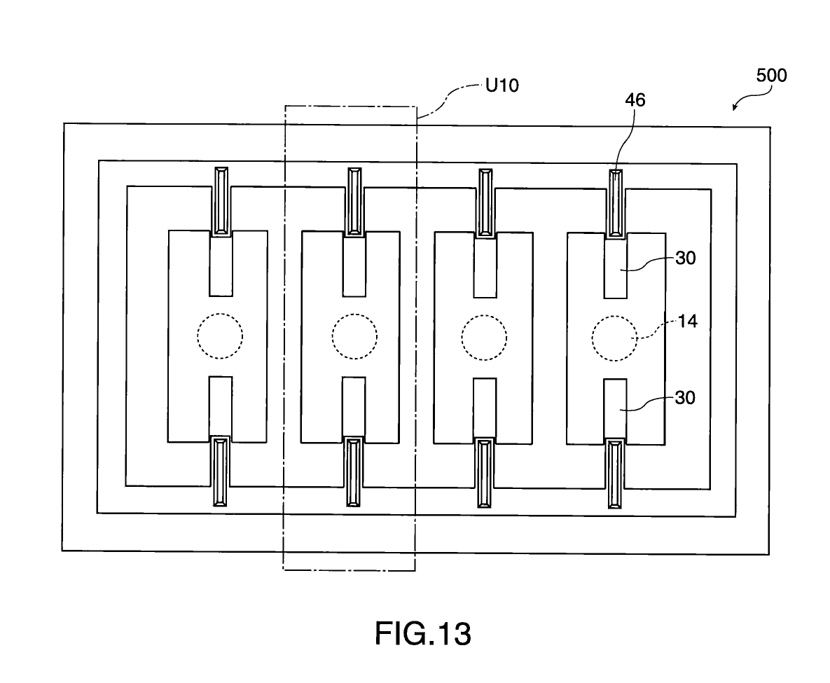

FIG. 13 is a schematic plan view of a liquid jet head 500 in accordance with a modified example of the third embodiment. As indicated by a broken line in FIG. 13, the structure of the liquid jet head 100 in accordance with the first embodiment can correspond to a unit U10. The liquid jet head 500 has units U10 each defining the liquid jet head 100 described above, and has a structure in which the units U10 are repeatedly disposed in a line such that nozzle apertures 14 are aligned. In the liquid jet head 500, a pressure chamber 12 and a nozzle aperture 14 are provided for each pressure chamber substrate 10. The structure, operations, manufacturing method and the like for each of the units U10 of the liquid jet head 500 are generally the same as those of the liquid jet head 100 described above, and therefore their detailed description shall be omitted.

In the liquid jet head 500, each of the units U10 can be independently driven, and different kinds of liquid can be filled in the pressure chambers 12, respectively. By this, the liquid jet head 500 can be used as a so-called line head in which the multiple nozzle apertures 14 are arranged in a line. As a result, for example, when the liquid jet head 500 is used for printing, the printing speed can be increased. The liquid jet head 500 can be made smaller in size compared to conventional line heads, and excels in liquid discharging force.

In the present embodiment, the unit U10 may have any one of the structures of the liquid jet heads described above. Next, as an example, the case where the unit U10 has the same structure as that of the above-described liquid jet head 400 is described.

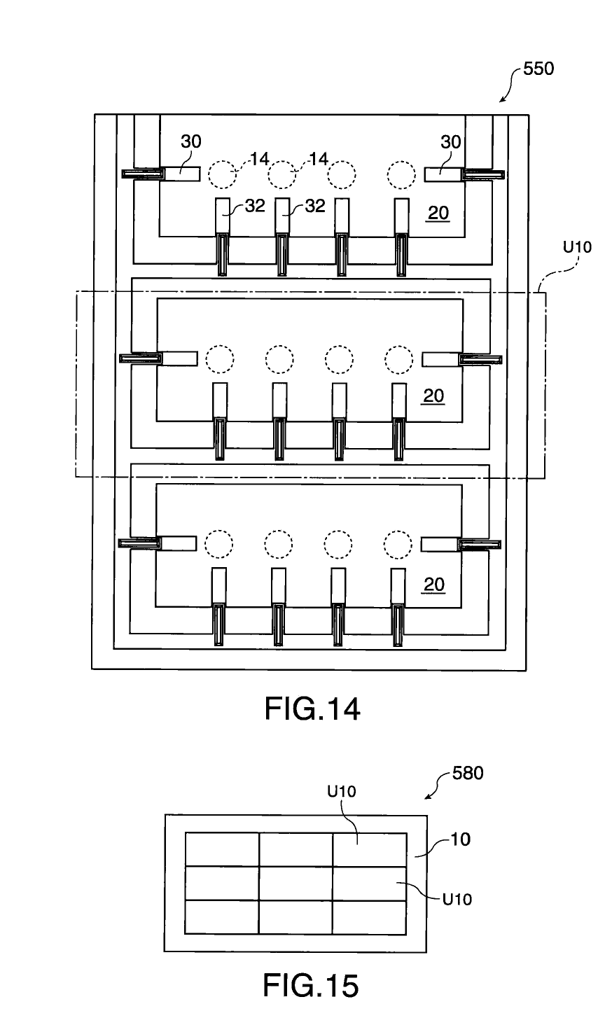

FIG. 14 is a schematic plan view of a liquid jet head 550 in accordance with an embodiment of the invention.

The liquid jet head 550 has a plurality of pressure chambers 12 arranged in a line in a pressure chamber substrate 10. In the illustrated example, three pressure chambers 12 are arranged in a line. Members and operations of the liquid jet head 550 are substantially the same as those of the first and second embodiments, except the difference of the specific structure described above. Detailed description of the contents that may be repetitive of the first and second embodiments shall be omitted.

The liquid jet head 550 has units U10 each defining the liquid jet head 400 described above, and has a structure in which the units U10 are disposed in a line in parallel with each other in a common pressure chamber substrate 10. The pressure chambers 12 may be provided in plural. However, when the number of the pressure chambers 12 is 2 raised to the power of n (n is a natural number), their operation can be controlled in a similar manner as controlling the operation of a semiconductor memory, and therefore the control efficiency is improved.

The nozzle apertures 14 of the liquid jet head 550 are arranged in a line (in the first direction) in each of the units U10 (the liquid jet head 400), and also are arranged in a matrix as a plurality of pressure chambers 12 are disposed in parallel with one another such that the nozzle apertures 14 are also aligned in another direction (second direction) traversing the lines in the first direction. In the present embodiment, an example in which rows and columns of the matrix of the nozzle apertures 14 are orthogonal to each other is described, but the rows and columns may diagonally traverse each other.

As the liquid jet head 550 has the nozzle apertures 14 disposed in a matrix, it can be driven in a manner similar to a semiconductor memory. More specifically, assuming the nozzle apertures 14 arranged linearly in a row direction in each one of the pressure chambers 12 are in a row in a memory, and the nozzle apertures 14 arranged in a column direction in which the pressure chambers 12 are arranged are in a column in the memory, the liquid jet head 550 could be driven like the semiconductor memory. As a result, a control method generally used for an ordinary memory can be applied to the present embodiment.

Also, in accordance with the present embodiment, as the nozzle apertures 14 are arranged in a matrix, redundancy relief control, which may be performed in a memory, can be similarly performed in its control if defects such as clogging of any of the nozzle apertures 14 occur at the time of manufacturing or in use. Accordingly, the manufacturing yield and reliability can be improved.

In accordance with the present embodiment, the units U10 can be disposed in a matrix.

FIG. 15 is a plan view schematically showing an arrangement of the units U10 of a liquid jet head 580 in accordance with the present embodiment. As shown in FIG. 15, by disposing the units U10 in a matrix in a single pressure chamber substrate 10, nozzle apertures 12 are disposed in a matrix. Then, liquid can be discharged at any desired timing by each of the units U10. In other words, the liquid jet head 580 in accordance with the present embodiment can be used as a planar head. Therefore the liquid jet head 580 has nozzle apertures 14 arranged in a matrix even when a single nozzle aperture 14 is provided for each of the pressure chambers 12. For this reason, when the liquid jet head 580 is used, for example, for printing liquid (ink) on a medium such as paper or the like, the printing speed can be dramatically increased.

### 4. FOURTH EMBODIMENT

### 4.1. PRINTER

Next, a printer 600 having any of the liquid jet heads described above is described. Here, the description is made as to the case where the printer 600 in accordance with an embodiment is an ink jet printer.

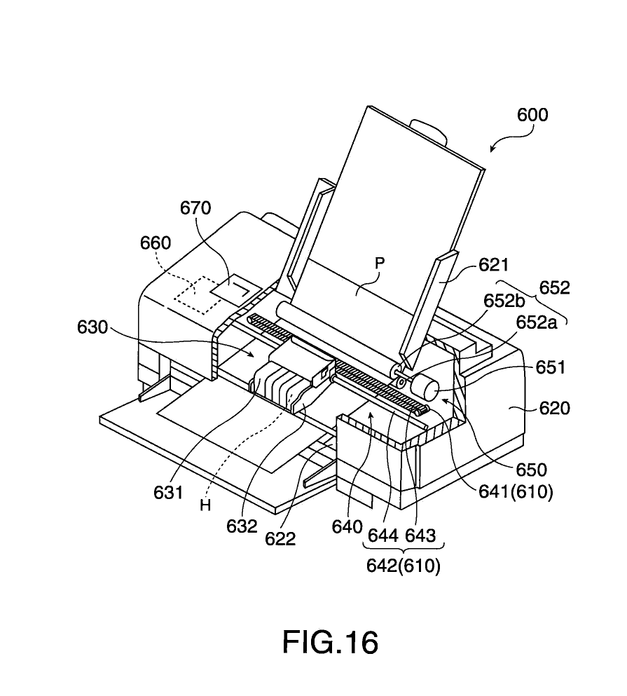

FIG. 16 is a schematic perspective view of a printer 600 in accordance with the present embodiment. The printer 600 includes a head unit 630, a driving section 610 and a control section 660. Also, the printer 600 may include an apparatus main body 620, a paper feeding section 650, a tray 621 for holding recording paper P, a discharge port 622 for discharging recording paper P, and an operation panel disposed on an upper surface of the apparatus main body 620.

The head unit 630 has an ink jet recording head (hereafter simply referred to as a “head”) formed from any of the liquid jet heads described above (indicated by a sign H in the figure). The head unit 630 is further equipped with an ink cartridge 631 that supplies ink to the head, and a carriage section (carriage) 632 on which the head and the ink cartridge 631 are mounted.

The driving section 610 is capable of reciprocating the head unit 630. The driving section 610 includes a carriage motor 641 that is a driving source for the head unit 630, and a reciprocating mechanism 642 that receives rotations of the carriage motor 641 to reciprocate the head unit 630.

The reciprocating mechanism 642 includes a carriage guide shaft 644 having both ends thereof supported by a frame (not shown), and a timing belt 643 that extends in parallel with the carriage guide shaft 644. The carriage guide shaft 644 supports the carriage 632 while freely reciprocally supporting the carriage 632. Further, the carriage 632 is affixed to a portion of the timing belt 643. By operations of the carriage motor 641, the timing belt 643 is moved, whereby the head unit 630 is reciprocates, guided by the carriage guide shaft 644. During these reciprocal movements, ink is discharged from the head and printed on the recording paper P.

The control section 660 is capable of controlling the head unit 630, the driving section 610 and the paper feeding section 650.

The paper feeding section 650 is capable of feeding the recording paper P from the tray 621 toward the head unit 630. The paper feeding section 650 includes a paper feeding motor 651 as its driving source and a paper feeding roller 652 that is rotated by operations of the paper feeding motor 651. The paper feeding roller 652 is equipped with a follower roller 652a and a driving roller 652b that are disposed up and down and opposite each other with a feeding path of the recording paper P being interposed between the two rollers. The driving roller 652b is coupled to the paper feeding motor 651.

The head unit 630, the driving section 610, the control section 660 and the paper feeding section 650 may be provided inside the apparatus main body 620.

It is noted that, in the example described above, the printer 600 is an ink jet printer. However, the printer in accordance with the invention can also be used in semiconductor manufacturing process as an industrial droplet discharging device. The printer in accordance with the invention can be used for industrial purposes, such as, for example, for coating liquid on media other than paper.

The printer 600 in accordance with the present embodiment has a liquid jet head in accordance with any of the embodiments described above in its recording head section, such that the droplet coating performance on printing objects is excellent. In other words, the printer 600 in accordance with the present embodiment exhibits high ink discharging force at the time of printing, its head would not readily be deteriorated, and its reliability is high.

The invention may include compositions that are substantially the same as the compositions described in the embodiments (for example, a composition with the same function, method and result, or a composition with the same objects and result). Also, the invention includes compositions in which portions not essential in the compositions described in the embodiments are replaced with others. Also, the invention includes compositions that achieve the same functions and effects or achieve the same objects of those of the compositions described in the embodiments. Furthermore, the invention includes compositions that include publicly known technology added to the compositions described in the embodiments.

What is claimed is:

1. A liquid jet head comprising:
a pressure chamber substrate having a pressure chamber that is filled with liquid, and at least one nozzle aperture that is provided below the pressure chamber and connects to the pressure chamber;
a vibration layer that is provided above the pressure chamber substrate and composes an upper surface of the pressure chamber;
at least one cantilever beam section that is provided above the vibration layer and has a tip portion protruding above the pressure chamber in a plan view; and
a piezoelectric element that is provided above the beam section and drives the beam section,
wherein a plurality of the beam sections are provided, each of the beam sections operable to give vibration to the vibration layer, the vibration layer deforms by a plurality of the vibrations superposed propagating in the vibration layer, and the liquid is ejected through the nozzle aperture by the deformation of the vibration layer.

2. A liquid jet head according to claim 1, wherein the deformation of the vibration layer has a maximum magnitude above the nozzle aperture.

3. A liquid jet head according to claim 1, wherein the beam section has a tip portion protruding toward the nozzle aperture in a plane view.

4. A liquid jet head according to claim 1, wherein at least two of the beam sections are provided opposite to each other through the nozzle aperture.

5. A liquid jet head according to claim 4, wherein a plurality of the nozzle apertures are arranged in a first direction that connects centers of the beam sections provided opposite to one another.

6. A liquid jet head according to claim 5, comprising first beam sections provided along the first direction, and having tip sections protruding toward the nozzle apertures located at both ends of the first direction.

7. A liquid jet head according to claim 5, comprising second beam sections that are provided along a second direction traversing the first direction, and arranged opposite to one another through the nozzle apertures.

8. A liquid jet head according to claim 1, wherein the pressure chamber substrate has a plurality of pressure chambers.

9. A liquid jet head according to claim 8, wherein the plurality of pressure chambers are arranged in a line.

10. A liquid jet head according to claim 8, wherein the plurality of pressure chambers are arranged in a matrix.

11. A liquid jet head according to claim 8, wherein the plurality of pressure chambers are disposed such that the nozzle apertures are arranged in a matrix.

12. A liquid jet head according to claim 11, wherein at least one of the nozzle apertures disposed in a matrix is an auxiliary nozzle aperture.

13. A method for driving the liquid jet head recited in claim 1, wherein a plurality of vibrations given by a plurality of beam sections and propagating in the vibration layer are mutually different from one another in at least one of phase, cycle and amplitude.

14. A method for driving a liquid jet head according to claim 13, wherein the plurality of vibrations are mutually different in cycle.

15. A method for driving a liquid jet head according to claim 13, wherein each of the cycles of the plurality of vibrations is a multiple of a specified cycle.

16. A printer quipped with the liquid jet head set forth in claim 1.
